(19) United States
(12) Patent Application Publication
(10) Pub. No.: US 2026/0348408 A1
(43) Pub. Date: Nov. 5, 2026

(54) WORKING CYLINDER

(71) Applicant: BÜMACH ENGINEERING INTERNATIONAL B.V., TA Emmen (NL)

(72) Inventor: Josef BUETER, Hasen/Altenberge (DE)

(21) Appl. No.: 19/125,330

(22) PCT Filed: Sep. 28, 2023
(86) PCT No.: PCT/DE2023/000118

§ 371 Date: Apr. 29, 2025

(30) Foreign Application Priority Data
Nov. 14, 2022 (DE) 20 2022 002 445.2

(51) Int. Cl. F15B 15/14

(52) U.S. Cl. CPC F15B 15/1428; F15B 15/1447

(57) ABSTRACT

A cylinder has a bottom-side joint head with a bottom-side joint head main body and a bottom-side joint bearing. The bottom-side joint head main body has a bottom-side concentric receiving bore to receive the bottom-side joint bearing. The bottom closure part has a shaped portion has a concave indentation which forms a bottom-side receiving portion which has a bottom-side radial inner lateral surface that corresponds to the bottom-side radial annular body outer lateral surface. The bottom-side joint head main body is welded, at a bottom-side radial annular body outer lateral partial surface, to the bottom closure part, at the bottom-side radial inner lateral surface, by a bottom-side annular-segment-shaped laser weld seam.

The invention relates to a working cylinder with coupling portions for an articulated coupling with a device to be actuated.

It is known from the prior art to couple working cylinders with devices to be actuated via connection modules for the purpose of power transmission. In particular, joint heads are disclosed as connection modules in the state of the art.

Joint heads are produced in particular as flame-cut or forged parts and accommodate, in a joint-eye, a joint bearing that can have different degrees of freedom in order to couple the working cylinder free of bending stresses.

To couple the joint head to a bottom closure part, it is known from the prior art to use MAG welding to produce a positive substance coupling. The disadvantage of this method is that not only the size but also the shape of the joint heads is determined depending on the working cylinder to be coupled so that their provision becomes more expensive. Normally, the joint head is provided with a straight outer contour section that is welded flat onto the covering surface of the bottom closure part. To absorb the high forces, MAG weld seam is generously dimensioned. The material deposit, which is provided as a welding bead in the throat and can be up to 15 mm, disadvantageously requires an additional allowance with respect to the distance of the outer contour section to the so-called joint eye in order to ensure sufficient free space for movement around the joint eye. Due to the large amount of heat generated during welding, either temperature-sensitive components, such as joint bearings in particular, can only be mounted after welding, or an additional material allowance of at least 30% of the mass must be provided at the joint head in order to allow the heat to dissipate sufficiently.

To couple a joint head to a piston rod, a screw connection is particularly known in the prior art. On the one hand, an external thread has to be milled on the piston rod for this purpose and, on the other hand, a blind hole with an internal thread has to be prepared at the joint head. Besides the considerable effort required to produce the thread pairing, a disadvantage is that a necessary minimum length of the thread must also be observed, to which another length allowance may be added for spanner flats that also have to be milled and that are intended for applying a torque or for counter-holding when the screw connection is produced.

The object of the invention is to provide a working cylinder that can be coupled by means of a joint head, requires small installation space and can be produced with reduced material consumption and in less time.

The problem is solved by the features specified in claim 1 and, according to a further aspect of the invention, by the features specified in claim 8. Preferred further developments arise from the sub-claims.

The working cylinder according to the invention comprises a cylinder and a piston unit as basic elements and is characterized by a specially designed coupling portion with a joint head.

The cylinder of the working cylinder according to the invention comprises a cylinder tube, a first closure part and a second closure part in a manner known per se.

In this design, the cylinder tube has two opposing cylinder tube ends. The two opposing cylinder tube ends are hereinafter referred to as the first cylinder tube end and the second cylinder tube end, and collectively as the cylinder tube ends.

The first closure part is arranged at the first cylinder tube end and the second closure part is arranged at the second cylinder tube end. Hereinafter, the first closure part and the second closure part are also referred to collectively as the closure parts. The first closure part is designed as a guide closure part and the second closure part is designed as a bottom closure part.

The cylinder tube and the closure parts arranged thereon form a cylinder interior. For this reason, the two closure parts are designed in such a way that they are connected to the respective cylinder tube ends in a pressure-tight manner. To connect the two closure parts, they are preferably laser welded to the cylinder tube along the common circumferential contact surface.

The piston unit forms at least one working chamber in the cylinder interior. The piston unit is preferably designed as an assembly of piston and piston rod, wherein the piston rod slidingly passes through the guide closure part. The piston unit can also be designed, for example, as a plunger piston or as a piston unit of a double-rod cylinder. However, the working cylinder according to the invention can also be of other types, it can also be, in particular, a differential working cylinder or a traction cylinder. Preferably, without limitation, it is a hydraulic cylinder.

The piston unit comprises an outer end portion. The outer end portion is to be understood as the distal head portion of the piston unit, preferably of the piston rod, located outside the cylinder interior. In the case of a plunger cylinder, it is the distal head of the plunger piston.

The working cylinder according to the invention is also characterized by a specially designed coupling portion.

The coupling portion in the meaning of the present invention is understood to be the part of the working cylinder that is connected to a device to be actuated, for example, an excavator arm, and via which the forces provided by the working cylinder are transmitted or the forces caused by the device to be actuated are absorbed. The device to be actuated itself is not part of the working cylinder according to the invention. It merely represents the functional context of the working cylinder according to the invention. Normally, two opposing coupling portions are arranged at the working cylinder, wherein at least one coupling portion is designed according to the invention.

According to the first independent claim of the invention, the working cylinder comprises a bottom-side joint head for this purpose.

The bottom-side joint head comprises a bottom-side joint head main body and a joint bearing provided therein. The joint bearing serves to couple the working cylinder to a device to be actuated by means of a coupling bolt in a manner that is optimized in terms of friction and free of torque in at least one rotational degree of freedom.

The bottom-side joint head main body is designed as a ring body according to the invention. A ring body is understood to be a rotationally symmetrical component that, in contrast to the cast or forged parts known from the prior art, can be advantageously provided in a high precision by a simple turning operation. Preferably, the ring body has a substantially hollow cylindrical basic shape.

The bottom-side joint head main body has a concentric receiving bore in which he joint bearing is received.

In addition, the bottom-side joint head main body has an annular body outer lateral surface. This surface extends circumferentially in the radial direction on the outer surface of the annular body.

According to the invention, the bottom closure part of the working cylinder has a specially designed bottom closure part shaped portion.

The bottom closure part shaped portion is formed as a monolithic portion of the bottom closure part and is provided in particular by a milling operation. The bottom closure part shaped portion rises from the outer base closure part covering surface in an axial distal direction above the plane defined by it. The bottom closure part shaped portion has a projection-like basic shape that follows a radius. A projection-like basic shape is understood to be a substantially prismatic body the base and top surfaces of which are arranged transversely to the bottom closure part covering surface. A basic shape following the radius is understood to mean that the bottom closure part shaped portion has a concave indentation in its substantially prismatic basic shape. At the concave indentation, there is a concavely curved surface that geometrically forms a portion of a cylinder lateral surface and is hereinafter referred to as the bottom-side radial inner lateral surface.

The concave indentation forms a receiving portion. The receiving portion is shaped such that it has a radial inner lateral surface corresponding to the radial outer lateral surface of the annular body. As an advantage, the shape of a lateral cylinder surface portion of the receiving portion allows for a flat reception of the joint head main body. The portion of the radial outer annular body lateral surface, which rests flat against the radial inner lateral surface of the concave receiving portion of the bottom closure part shaped portion, is hereinafter also referred to as the annular body outer lateral partial surface.

This surface contact advantageously allows a high-power transmission of compressive forces, as they occur in particular when the working cylinder is in an extension operating state. At the same time, the corresponding surfaces provide a partial positive fit between the joint head main body and the bottom closure part, which counteracts twisting and tilting of the joint head main body.

The bottom-side joint head main body is welded, at a radial annular body outer lateral partial surface of the radial annular body outer lateral surface, to the bottom closure part at the radial inner lateral surface by means of a bottom-side annular-segment-shaped laser weld seam. The full-surface welding of the joint head main body and the bottom closure part on the corresponding surfaces produces a reliable positive substance connection between the two parts and makes the transmission of high tensile forces possible, as they occur in particular in when the working cylinder is in a retraction operating state.

The solution according to the invention for providing a working cylinder that can be coupled in an articulated manner has the following advantages in particular.

A solution has been created surprisingly by means of a combination of a flat fit of corresponding cylinder lateral partial surfaces and a precise laser annular-segment-shaped weld seam, by means of which the disadvantages known from prior art solutions for the production of joint heads are overcome in a simple manner. Neither elaborate thread milling is required, nor do the disadvantages of imprecise and heat-intensive MAG welding, associated with high material deposition, exist.

Furthermore, the bottom closure part can be provided in a particularly simple and cost-effective manner as a turned part. Due to its simple geometry, the bottom closure part shaped portion can also be produced using a conventional milling machine in the same technological process as the bottom closure part, without he need for an additional processing station. This results in a major advantage concerning the production effort and the associated production costs. The low energy input per unit length of the laser welding allows for small heat-affected zones so that thermal damage or deformation of the bottom closure part or the joint head main body can be avoided. In particular, laser welding according to the invention is also possible with previously installed sensitive components such as polymer seals or the like.

In addition, the disadvantages of the state of the art, as existing for MAG welding, can be overcome by laser welding the joint head main body to the bottom closure part, even in the case of a joint bearing that has already been mounted. This makes it possible to manufacture the joint head as a finished assembly of the joint head main body and the joint bearing in mass production and with high precision before welding. This has the advantage of achieving higher accuracies and smaller tolerances.

In an advantageous further development, the working cylinder is characterized in that a bottom-side pressure medium connection bore is arranged, at least in sections, in the bottom closure part shaped portion.

According to this further development, it is advantageous that the instillation space provided by the bottom closure part shaped portion is simultaneously used for the arrangement of the pressure medium connection bore. Thus, the overall length of the working cylinder can be reduced for the same stroke length by using the axially distal projection of the bottom closure part shaped portion.

The advantage of this is that a functional integration is created by the bottom closure part shaped portion as the bottom closure part shaped portion, firstly, receives the joint head in a force-transmitting manner and, secondly, creates an installation space axial-distally beyond the bottom closure covering surface for receiving the pressure medium connection bore.

In a particular variant based on this design, the working cylinder is characterized in that the bottom-side pressure medium connection bore distally exceeds, at least in sections, a transverse plane to a longitudinal axis, spanned by a vertex line of the receiving portion.

The vertex line of the receiving portion is the point at which the bottom closure part shaped portion has the slightest elevation above the bottom closure part covering surface and, in an assembled state, the joint head main body extends furthest in the proximal direction.

Thus, the pressure medium connection can be arranged in the bottom closure part in an area with the greatest material overlap and, at the same time, very far distally. This design results in a maximum flexural stiffness of the connection. Thus, a particularly large reduction in the overall length is advantageously possible without affecting the stroke length.

According to a further advantageous development, the working cylinder is characterized in that it has a rod-side joint head which forms the rod-side articulated coupling of the working cylinder to a device to be actuated.

The rod-side joint head also has a joint head main body—hereinafter referred to as the rod-side joint main body—and a joint bearing—hereinafter referred to as the rod-side joint bearing. Therefore, the description contents for the bottom-side joint head and its arrangement at the working cylinder also apply accordingly to the rod-side joint head, unless special features result from the following descriptive sections.

The rod-side joint head main body is also designed as an annular body. It has a rod-side concentric receiving bore. The rod-side joint bearing is correspondingly received in it. Like the bottom-side joint head main body, the rod-side joint main body also has a substantially hollow cylindrical basic shape. The joint head main body also has a rod-side radial annular body outer lateral surface.

The piston unit has a rod-side shaped portion at the outer end portion.

The rod-side shaped portion corresponds to the bottom closure part shaped portion, taking into account the special rod-side features. The rod-side shaped portion is machined from the cylindrical basic shape of the outer end portion of the piston unit, preferably by milling. Afterwards, it is formed as a monolithic portion of the piston unit. Accordingly, the rod-side shaped portion rises in an axially distal direction above the cylindrical portion of the piston unit and has a projection-like basic shape that follows a radius. The rod-side shaped portion has a concave indentation that forms a rod-side receiving portion. Furthermore, the rod-side receiving portion has a radial inner lateral surface corresponding to the radial annular body outer lateral surface.

The rod-side shaped portion is an exact receiving counter-form in diameter and preferably also in width to the outer lateral surface of the joint head main body. The rod-side receiving portion is preferably limited in length by the outer diameter of the piston rod.

For the form-fit connection of the rod-side shaped portion to the rod-side joint head main body, the latter is welded, at a rod-side radial annular body outer lateral partial surface of the rod-side radial annular body outer lateral surface to the piston unit at the rod-side radial inner lateral surface by means of a rod-side annular-segment-shaped laser weld seam.

According to a particularly advantageous further development, the working cylinder with rod-side and bottom-side joint head is characterized in that the bottom-side joint head main body and the rod-side joint head main body are designed as identically constructed components.

This is advantageous for the production of the joint heads. In addition, there are also considerable advantages for the production logistics of the working cylinder because different joint heads for the bottom side and the rod side do not have to be taken into account. In connection with the low thermal stress due to the annular-segment-shaped laser weld seam, it is rather possible to manufacture the joints as finished assemblies, consisting of a main body and a joint bearing, in large quantities and in high quality.

Furthermore, the invention offers the advantage that the joint heads can be manufactured in graduated sizes without specific manufacturer specifications, and that then, for adjustment purposes, only the bottom closure part shaped portion or the rod-side shaped portion has to be milled according to the respective size of the joint heads available in large quantities.

According to a further advantageous development, the working cylinder is characterized in that the bottom-side annular-segment-shaped laser weld seam or the rod-side annular-segment-shaped laser weld seam is formed as a double-sided weld seam.

The stability is advantageously increased by means of this design and thermal stress is simultaneously reduced because the energy per unit length introduced into the line is distributed over time.

Another aspect of the invention relates to a working cylinder, according to the independent sub-claim, which only has a rod-side joint head according to the invention.

The basic structure of the working cylinder, with regard to the cylinder, the cylinder tube, the closure parts and the piston unit, corresponds to the working cylinder according to the main claim so that the description given in that claim also applies in a corresponding manner to the working cylinder according to the independent sub-claim described here. Furthermore, the description contents of the main claim regarding the rod-side joint head and the formation of the rod-side shaped portion at the outer end portion of the piston unit apply in a corresponding manner to the additional rod-side joint head.

The invention is explained as an exemplary embodiment in more detail by means of the following figures. They show:

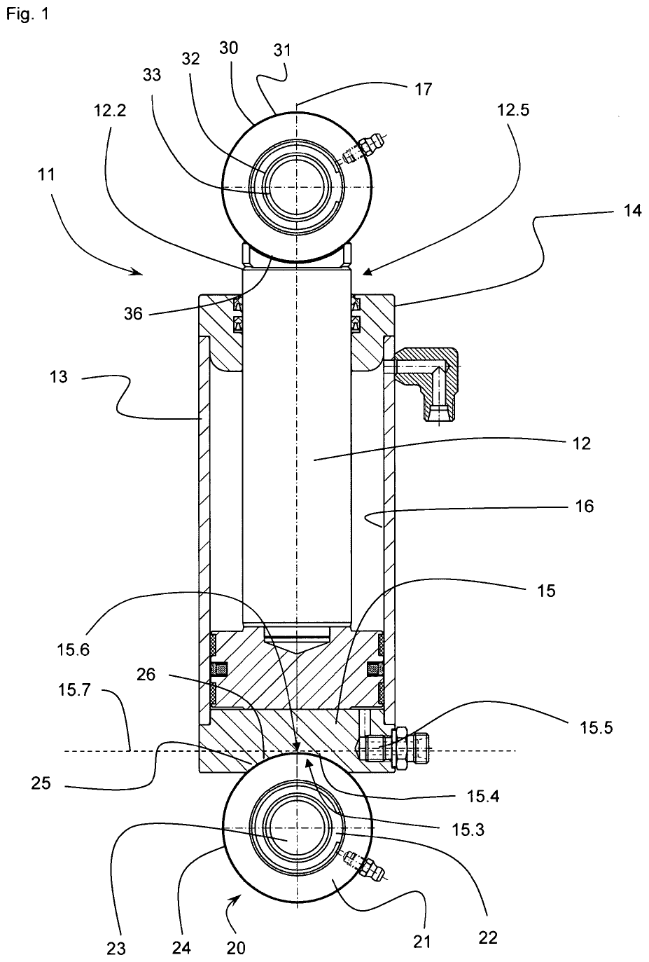

FIG. 1 Schematic representation of the working cylinder in a sectional view

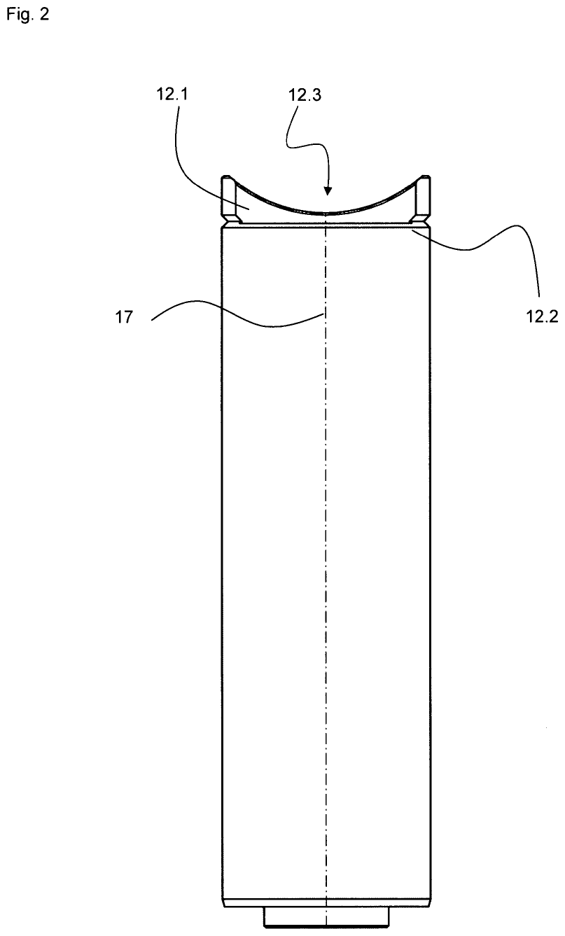

FIG. 2 Schematic representation of the piston rod in a lateral view

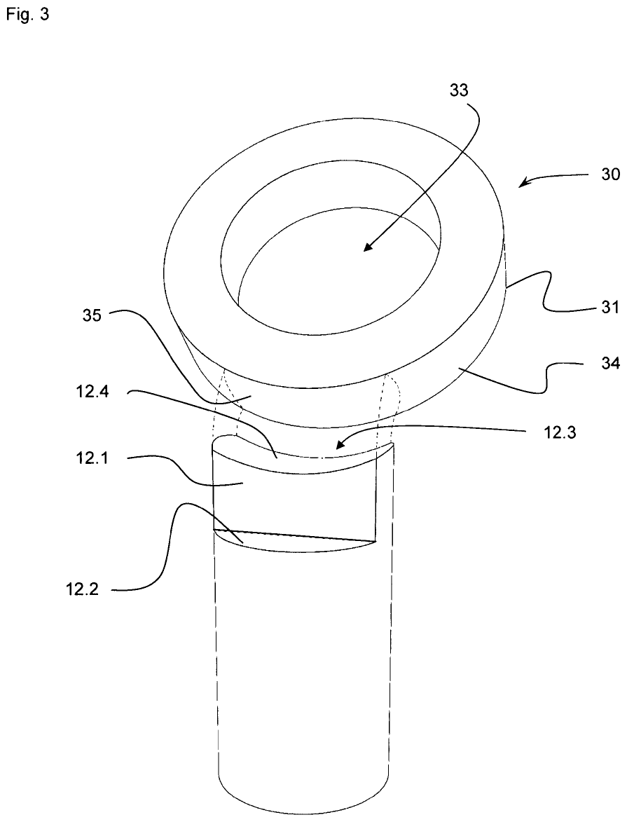

FIG. 3 Schematic representation of the piston rod-side shaped portion with the annular body

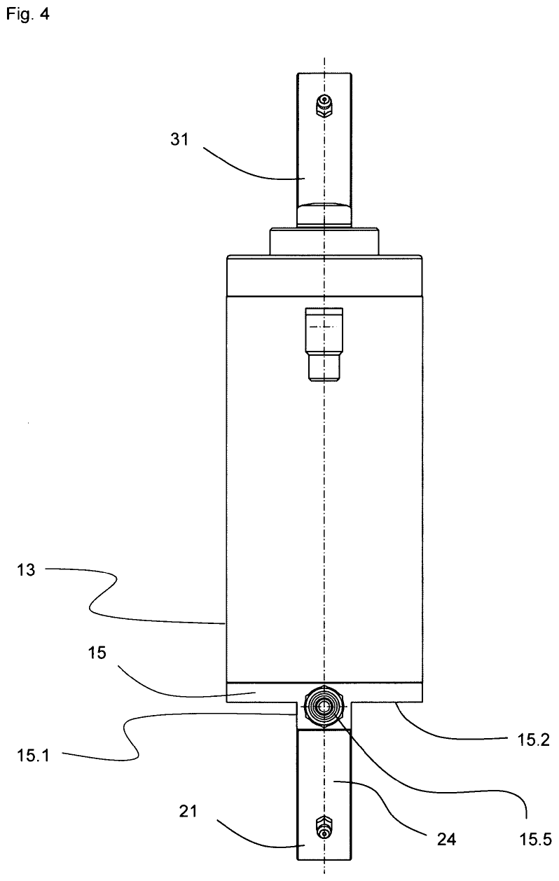

FIG. 4 Schematic representation of the working cylinder in a lateral view

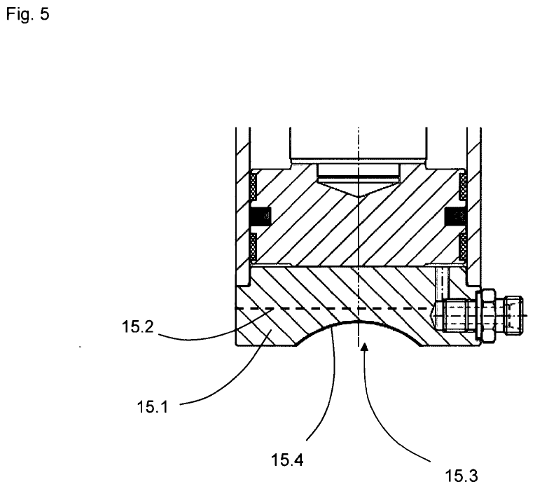

FIG. 5 Schematic representation of the bottom-side portion of the working cylinder in a sectional view.

In this context, the same reference numerals in the various figures always refer to the same features or components. The reference numerals are also used in the description even if they are not shown in the figure in question.

FIG. 1 shows a schematic sectional view of an exemplary embodiment of the working cylinder.

Its basic components are a cylinder 11 and a piston unit 12. The cylinder tube 13 is closed by a guide closure part 14 and a bottom closure part 15 and thus forms a cylinder interior 16.

In this exemplary embodiment, the working cylinder has a joint head 20, 30 being designed according to the invention both on the bottom side and on the rod side. The bottom-side joint head 20 and the rod-side joint head 30 are each designed as an annular body and specifically as a turned part.

The bottom-side joint head 20 comprises the bottom-side joint head main body 21 and the bottom-side joint bearing 22 pressed into the bottom-side receiving bore 23 of the latter. The bottom-side joint head main body 21 comprises a bottom-side radial annular body outer lateral surface 24.

The bottom closure part 15 comprises a bottom closure part shaped portion 15.1 designed in a special manner to receive the bottom-side joint head 20, wherein the sectional plane of the sectional view of the bottom closure part runs longitudinally through the bottom closure part shaped portion 15.1 in FIG. 1. The bottom closure part shaped portion 15.1 having a projection-like form—which is better to see in FIG. 4—comprises a circular concave bottom-side receiving portion 15.3 which follows the radius of the joint head main body 21 at its radial annular body outer lateral surface 24. The bottom-side receiving portion 15.3 forms a bottom-side radial inner lateral surface 15.4, the radius of which coincides with the bottom-side radial annular body outer lateral surface 24. The part of the bottom-side radial annular body outer lateral surface 24, that is congruent with the bottom-side radial inner lateral surface 15.4, is the bottom-side radial annular body outer lateral partial surface 25. These two surfaces 15.4, 25 are completely connected in a positive substance manner over the entire surface by means of the bottom-side annular-segment-shaped laser weld seam 26, which is applied on both sides. From a manufacturing point of view it is advantageous that the positive substance weld connection, in conjunction with the partial form fit due to the corresponding shape of the two surfaces 15.4, 25, allows both a reliable pre-positioning before welding and a particularly stable coupling after welding.

In addition, the bottom-side pressure medium connection bore 15.5 is arranged in sections in the bottom closure part shaped portion 15.1 in this exemplary embodiment. It is advantageously accommodated in the bottom closure part shaped portion 15.1 in such a way that it immerses into a transverse plane 15.7 spanned by the proximal vertex 15.6. Thanks to the bottom closure part shaped portion 15.1 is distally narrowed on both sides relative to the cylindrical diameter of the bottom closure part 15, there is sufficient space in the remaining projection for the bottom-side pressure medium connection bore 15.5. Therefore, the axial extension between the piston in its bottom-side end position at the bottom closure part 15 and the articulation point of the bottom-side joint head 20 can be significantly reduced, which is a decisive advantage because of the reduced required construction length of the working cylinder.

The rod-side joint head 30 is used to link the piston unit 12 to a device to be actuated. Analogous to the bottom-side joint head 20, a rod-side joint bearing 32 is also integrated into the rod-side joint head 30. It is received in the rod-side receiving bore 33 of the rod-side joint head main body 31. For receiving the rod-side joint head 30 at the outer end portion 12.5 of the piston unit 12, the piston rod comprises a rod-side receiving portion 12.3. It forms, with its concave shape, the counter-portion to the rod-side annular body outer lateral partial surface 35, which is a portion of the rod-side annular body outer lateral surface 34. The rod-side shaped portion 12.1 is set off distally in the width of the rod-side joint bearing 32. The full-cross-section end 12.2 is located there.

FIG. 2 shows a schematic representation of the piston rod of the piston unit 12. At its outer end portion 12.5, it comprises the rod-side shaped portion 12.1, which is designed to receive the rod-side joint head 30. For this reason, the rod-side shaped portion 12.1 is formed, based on the cylindrical diameter of the piston rod, by means of a material-removing manufacturing process, in particular by milling. For this purpose, two indentation areas are created on both sides distally and in parallel. This leads to a full-cross-section end 12.2 of the piston rod. Furthermore, the rod-side receiving portion 12.3 is introduced at the rod-side end of the piston rod perpendicular to the main longitudinal axis 17. This describes a circular sector with the same diameter which the bottom-side joint head main body 21 has.

FIG. 3 shows a schematic exploded view of the piston rod and the rod-side joint head 30. The rod-side joint head 30 is also shown slightly tilted for a better representation. In the rod-side joint head 30, the rod-side joint bearing 32—not shown in FIG. 3 for the sake of simplicity—is received in the rod-side joint head main body 31.

The piston rod comprises a rod-side shaped portion 12.1 at one end. It is provided by milling this area. This leads to a shoulder that results from the full-cross-section end 12.2 due to the removal of material by processing. For the rod-side shaped portion 12.1, a prismatic portion as a preliminary stage of the rod-side shaped portion 12.1 is first obtained from the cylindrical rod end by symmetrical milling on both sides. To receive the rod-side joint head 30, a concave rod-side receiving portion 12.3 corresponding to the cylindrical outer shape of the rod-side joint head 30 has been created afterwards. It forms a rod-side radial inner lateral surface 12.4 in the axial direction. This surface serves to receive the rod-side joint head 30, the cylindrical outer shape of which has a rod-side radial annular body outer lateral surface 34. The contact surface between the rod-side radial annular body outer lateral surface 34 and the rod-side radial inner lateral surface 12.4 forms a rod-side radial annular body outer lateral partial surface 35. All compressive forces of the cylinder are transmitted to a cylinder receiving unit via this surface. For a positive-substance assembly, an annular-segment-shaped laser weld seam 36 is produced axially to the rod-side receiving bore 33 between the rod-side radial annular body outer lateral partial surface 35 and the rod-side radial inner lateral surface 12.4 so that it connects these surfaces 12.4, 35. Thus, the piston unit 12 and the rod-side joint head 30 are reliably coupled.

FIG. 4 shows a schematic representation of the working cylinder, in particular the positional relationships of the bottom-side joint head 20 and the bottom closure part 15. Here, the bottom closure part 15 also has an originally cylindrical shape. The bottom closure part shaped portion 15.1 is milled out by means of two indentations that extend distally to the main longitudinal axis 17 of the cylinder. The projection width of this shaped portion corresponds to the axial extension of the bottom-side joint head main body 21. Thus, it is advantageously also sufficiently wide so that the bottom-side pressure medium connection bore 15.5 can also be arranged here. This results in a decisive advantage in terms of the construction space required, since the working cylinder can be made shorter overall. As a transition to the cylinder, the cylinder tube 13 and the bottom closure part 15 are also laser welded in the exemplary embodiment shown.

FIG. 5 shows in addition, in a sectional view of the bottom-side portion of the working cylinder, the bottom closure part shaped portion 15.1 still without the bottom-side joint head 20, wherein the dashed line indicates the boundary to the remaining bottom closure part 15, which is not visible due to the sectional plane, and at the same time the plane of the bottom closure part covering surface 15.2. The bottom closure part shaped portion 15.1 comprises the bottom-side receiving portion 15.3. The bottom-side receiving portion 15.3 forms the bottom-side radial inner lateral surface 15.4.

### REFERENCE NUMERALS

11 Cylinder
12 Piston unit
12.1 Rod-side shaped portion
12.2 Full-cross-section end
12.3 Rod-side receiving portion
12.4 Rod-side radial inner lateral surface
12.5 Outer end portion
13 Cylinder tube
13.1 First cylinder tube end
13.2 Second cylinder tube end
14 Guide closure part
15 Bottom closure part
15.1 Bottom closure part shaped portion
15.2 Bottom closure part covering surface
15.3 Bottom-side receiving portion
15.4 Bottom-side radial inner lateral surface
15.5 Bottom-side pressure medium connection bore
15.6 Proximal vertex
15.7 Transverse plane
16 Cylinder interior
17 Main longitudinal axis
20 Bottom-side joint head
21 Bottom-side joint head main body
22 Bottom-side joint bearing
23 Bottom-side receiving bore
24 Bottom-side radial annular body outer lateral surface
25 Bottom-side radial annular body outer lateral partial surface
26 Bottom-side annular-segment-shaped laser weld seam
30 Rod-side joint head
31 Rod-side joint head main body
32 Rod-side joint bearing
33 Rod-side receiving bore
34 Rod-side radial annular body outer lateral surface
35 Rod-side radial annular body outer lateral partial surface
36 Rod-side annular-segment-shaped laser weld seam

1-7. (canceled)

8. A working cylinder, comprising:
a cylinder having a cylinder tube, a guide closure part and a bottom closure part, said cylinder tube having a first cylinder tube end and a second cylinder tube end, said guide closure part arranged at said first cylinder tube end, and said bottom closure part arranged at the second cylinder tube end, said cylinder tube and said closure parts defining a cylinder interior,
a piston unit defining at least one working chamber in said cylinder interior, said piston unit slidingly passing through said guide closure part and having an outer end portion;
said cylinder including a bottom-side joint head having a bottom-side joint head main body and a bottom-side joint bearing, said bottom-side joint head main body being constructed as an annular body and having a concentric bottom-side receiving bore for receiving said bottom-side joint bearing, said main body having a bottom-side radial annular body outer lateral surface, said bottom closure part having a bottom closure part shaped portion being a monolithic portion of the bottom closure part and axially extending beyond an outer bottom closure part covering surface and having a projecting shape following a radius, said bottom closure part shaped portion having a concave indentation defining a bottom-side receiving portion, said bottom-side receiving portion having a bottom-side radial inner lateral surface corresponding to said bottom-side radial annular body outer lateral surface;
said bottom-side joint head main body being welded, at a bottom-side radial annular body outer lateral partial surface, to said bottom closure part at said bottom-side radial inner lateral surface by a bottom-side annular-segment-shaped laser weld seam.

9. The working cylinder according to claim 8, wherein a bottom-side pressure medium connection bore is arranged in the bottom closure part shaped portion at least in sections.

10. The working cylinder according to claim 9, wherein said bottom-side pressure medium connection bore distally exceeds, at least in sections, a transverse plane, spanned by a proximal vertex of said bottom-side receiving portion, to a main longitudinal axis of the cylinder.

11. The working cylinder according to according to claim 8, comprising a rod-side joint head having a rod-side joint head main body and a rod-side joint bearing, said rod-side joint head main body constructed as an annular body and having a concentric rod-side receiving bore for receiving said rod-side joint bearing, said rod-side joint head main body having a rod-side radial annular body outer lateral surface;
said piston unit, at an outer end portion thereof, having a rod-side shaped portion constructed as a monolithic portion of the piston unit and extending in an axially distal manner beyond a full-cross-section end and having a projecting shape that follows a radius, said rod-side shaped portion having a concave indentation defining a rod-side receiving portion with a rod-side radial inner lateral surface corresponding to said rod-side radial annular body outer lateral surface; and
said rod-side joint head main body being welded, at a rod-side radial annular body outer lateral partial surface, to said piston unit at said rod-side radial inner lateral surface by a rod-side annular-segment-shaped laser weld seam.

12. The working cylinder according to claim 11, wherein said bottom-side joint head main body and the rod-side joint head main body are provided as identically constructed turned parts.

13. The working cylinder according to claim 11, wherein said bottom-side annular-segment-shaped laser weld seam or said rod-side annular-segment-shaped laser weld seam are constructed as a double-sided weld seam.

14. A working cylinder, comprising:
a cylinder having a cylinder tube, a first closure part and a second closure part, said cylinder tube having a first cylinder tube end and a second cylinder tube end, said first closure part arranged at said first cylinder tube end, and said second closure part arranged at the second cylinder tube end, said cylinder tube and said closure parts defining a cylinder interior,
a piston unit defining at least one working chamber in said cylinder interior, said piston unit slidingly passing through said first closure part and having an outer end portion;
said piston unit having a rod-side joint head with a rod-side joint head main body and a rod-side joint bearing, said rod-side joint head main body being constructed as an annular body and having a concentric rod-side receiving bore receiving said rod-side joint bearing, said rod-side joint head main body having a rod-side radial annular body outer lateral surface;
said piston unit including a rod-side shaped portion at said outer end portion constructed as a monolithic portion of the piston unit and extending in an axially distal manner beyond a full-cross-section end and having a projecting shape following a radius;
said rod-side shaped portion having a concave indentation defining a rod-side receiving portion with a rod-side radial inner lateral surface corresponding to said rod-side radial annular body outer lateral surface,
said rod-side joint head main body being welded, at a rod-side radial annular body outer lateral partial surface, to said piston unit at the rod-side radial inner lateral surface by a bottom-side annular-segment-shaped laser weld seam.
